(19) United States
(12) Patent Application Publication
(10) Pub. No.: US 2007/0133361 A1
(43) Pub. Date: Jun. 14, 2007

(54) Removable medium recording/reproduction device, medium expelling control method for removable medium recording/reproduction device, and removable medium expelling control method for information processing apparatus

(75) Inventor: Yorio Takahashi, Ehime (JP)

Correspondence Address: STEPTOE & JOHNSON LLP, 1330 CONNECTICUT AVE., NW, WASHINGTON, DC, 20036, US

(73) Assignee: MATSUSHITA ELECTRIC INUDSTRIAL 10-6, OAZA KADOMA, JAPAN (JP)

(21) Appl. No.: 10/586,330

(22) PCT Filed: Jan. 19, 2005
(86) PCT No.: PCT/JP05/00589

§ 371 Date: Jul. 14, 2006

(30) Foreign Application Priority Data
Jan. 20, 2004 (JP) 2004-011258

(51) Int. Cl. G11B 7/085

(52) U.S. Cl. 369/30.27

(57) ABSTRACT

A removable medium recording/reproduction device capable of preventing expelling of a removable medium (101) by avoiding cancellation of an expelling prohibiting state even during power-down of the device. The device includes a mechanism for loading/ejecting a removable medium (101) by transporting the medium into the device and mounting the medium in a reproducible state, or by transporting and expelling it out of the device, a medium expelling prohibition information detector (110) which detects whether or not medium expelling prohibition information is recorded in a predetermined area on the medium (101), and a controller (106) which does not perform expelling of the medium due to a change in state of switches (104, 105) of the device or a command from outside if a record of the medium expelling prohibition information is detected by the medium expelling prohibition information detector (110) and which operates the loading/ejection mechanism to expel the medium according to the change in state of switches (104, 105) of the device or the command from outside if no record of the medium expelling prohibition information is detected.

### TECHNICAL FIELD

The present invention relates to a removable medium recording/reproduction device and to a method of controlling expelling of a removable medium in an information processing apparatus incorporating the removable medium recording/reproduction device. More particularly, the present invention relates to a technique of prohibiting expelling of a removable medium.

### BACKGROUND ART

Removable medium recording/reproduction devices, e.g., a CD-ROM drive and a semiconductor memory card capable of replacing a disk-type information storage medium (hereinafter referred to simply as “disk” as occasion demands) or a card-type recording medium have been generally used in information processing apparatuses such as personal computers and game machines.

Methods for replacement of such removable mediums are roughly divided into two kinds.

The first one is a mechanical method in which a user performs ejection or loading by mechanically operating a lid or a drawer-type tray so as to draw out/receive a disk, or in which a bare disk or a protective case containing a disk is expelled/taken in, thus performing ejection or loading for replacement of the disk.

In the second method, a drawing out/receiving of a lid or a drawer-type tray or expelling/taking-in of a bare disk or a protective case containing a disk is electrically performed by operating a switch or the like to perform ejection or loading for replacement of the disk.

In various devices and methods, expelling of a medium during recording/reproduction operation on the medium is prohibited because expelling of a medium during recording/reproduction operation may cause data destruction, or because expelling of a disk-type recording medium during the rotation of the medium may cause a scratch on the medium or injury by the rotation.

As a device for prohibiting expelling of a medium in such situations, a device according to the above-described first method, i.e., the mechanical method, is known which has, as disclosed in Japanese Patent Laid-Open No. 3-12852, a latching solenoid which prohibits the operation of an ejection mechanism, a prohibition canceller which cancels prohibition of the operation of the ejection mechanism by the latching solenoid after a lapse of a certain time period after power-down, and a battery which is normally charged, and which supplies power to the latching solenoid and the prohibition canceller.

In the above-described second method, i.e., the electrical method, control is ordinarily performed to prohibit acceptance of a medium expelling command or the operation of a medium expelling switch during recording/reproduction on a medium, or medium expelling prohibition is controlled according to a medium expelling prohibition/expelling prohibition cancellation command. Some electrical methods enable amedium to be forcefully expelled mechanically by inserting a pin through a hole provided in a front surface of the device face in the event of an emergency, e.g., power-down or an appliance malfunction.

### DISCLOSURE OF THE INVENTION

### Problem to be Solved by the Invention

The above-described methods of prohibiting expelling of a medium, however, cannot be used in a case where from the viewpoint of security there is a need to prevent a medium from being easily expelled, because expelling of the medium is prohibited by an ordinary command, and because the expelling prohibited condition is cancelled during power-down.

It is, therefore, an object of the present invention to provide a removable medium recording/reproduction device, a medium expelling control method for the removable medium recording/reproduction device and a removable medium expelling control method for an information processing apparatus capable of preventing expelling of a medium by maintaining an expelling prohibited condition even during power-down of the device. Means for Solving the Problem

To achieve the above-described object, according to the present invention, there is provided a removable medium recording/reproduction device having a removable medium loading/ejection mechanism which operates according to a change in state of switches each provided on an outer portion or on an inner portion of the device or according to a command from the outside of the device to transport a removable medium into the device and to set the removable medium in a reproducible state or to transport and expel the removable medium out of the device, the device including a medium expelling prohibition information detector which detects whether or not medium expelling prohibition information is recorded in a predetermined area on a removable medium, and a controller which, if a record of medium expelling prohibition information is detected by the medium expelling prohibition information detector, does not perform expelling of the medium due to a change in state of the switches or a command from the outside of the device, and which, if no record of medium expelling prohibition information is detected by the medium expelling prohibition information detector, operates the removable medium loading/ejection mechanism to expel the medium according to the change in state of the switches or the command from the outside of the device.

According to the above-described arrangement, prohibition of expelling of the removable medium is controlled by using medium expelling prohibition information recorded in a predetermined area on the removable medium, thereby ensuring that the expelling prohibiting state is not canceled even during power-down of the device, and that determination can be made as to whether or not each of mediums inserted into the device is allowed to be expelled by a user.

There is also provided a removable medium recording/reproduction device in another form including a medium expelling prohibition information detector which detects whether or not medium expelling prohibition information is recorded in a predetermined area on a removable medium, a removable medium detector which detects whether or not a removable medium is in the device, and a controller which does not perform expelling of the medium due to a change in state of the switches or a command from the outside of the device during detection of the existence/nonexistence of the removable medium by the removable medium detector, during detection by the medium expelling prohibition information detector as to whether or not medium expelling prohibition information on the removable medium is recorded, or if a record of medium expelling prohibition information is detected by the medium expelling prohibition information detector, and which, if the existence of a removable medium in the device is detected by the removable medium detector, and if no record of medium expelling prohibition information on the removable medium is detected by the medium expelling prohibition information detector, operates the removable medium loading/ejection mechanism to expel the medium according to the change in state of the switches or the command from the outside of the device.

According to the above-described arrangement, prohibition of expelling of the removable medium is controlled by using medium expelling prohibition information recorded in a predetermined area on the removable medium, and expelling of the removable medium is prohibited during detection as to the existence/nonexistence of the removable medium, or before determination as to whether or not expelling prohibition information is recorded on the medium immediately after power-on of the device, thereby ensuring that expelling of the medium is prevented immediately after power-on of the device, that the expelling prohibiting state is not cancelled even during power-down of the device, and that determination can be made as to whether or not each of mediums inserted into the device is allowed to be expelled by a user.

The removable medium loading/ejection mechanism is arranged to be incapable of forcibly expelling the removable medium during power-down of the device.

According to the above-described arrangement, forced expelling cannot be performed during power-down of the device, so that forced expelling of the medium using a forced expelling mechanism is prevented.

The controller expels the medium according to the change in state of all the switches or the command from the outside of the device in the time period from reception of a medium expelling prohibition cancellation command from the outside of the device to detection of medium expelling prohibition information in the predetermined area on the removable medium performed by the medium expelling prohibition information detector upon reinsertion of the removable medium into the device.

According to the above-described arrangement, medium expelling prohibition is canceled after the reception of a medium expelling prohibition cancellation command, and the canceled state is maintained before the medium is again inserted in the medium expelling prohibited device, and before the record of the medium expelling prohibition information in the predetermined area on the medium is detected.

The medium expelling prohibition information includes a medium expelling prohibition cancellation code, and the controller accepts the medium expelling prohibition cancellation command as a valid command only if the medium expelling prohibition cancellation command includes the medium expelling prohibition cancellation code or data obtained by converting the medium expelling prohibition cancellation code by a certain rule.

According to the above-described arrangement, medium expelling prohibition is cancelled only when the medium expelling prohibition cancellation command including the medium expelling prohibition cancellation code included in the medium expelling prohibition information recorded on the removable medium or data obtained by converting the medium expelling prohibition cancellation code by a certain rule is received, and the canceled state is maintained before the medium is again inserted in the medium expelling prohibited device, and before the record of the medium expelling prohibition information in the predetermined area on the medium is detected.

There is also provided a removable medium recording/reproduction device in still another form having a removable medium loading/ejection mechanism which operates according to a change in state of switches each provided on an outer portion or on an inner portion of the device or according to a command from the outside of the device to transport a removable medium into the device and to set the removable medium in a reproducible state or to transport and expel the removable medium out of the device, the device including a nonvolatile storage which is capable of holding storage contents even after power supply for the removable medium recording/reproduction device has been shut off, and which is rewritable, a medium expelling prohibition information detector which detects whether or not medium expelling prohibition information is recorded in a predetermined area on a removable medium, and a controller which records a medium expelling prohibition flag in the nonvolatile storage when the medium expelling prohibition information detector detects a record of medium expelling prohibition information, which, if the medium expelling prohibition flag is recorded in the nonvolatile storage, does not perform expelling of the medium due to a change in state of the switches or a command from the outside of the device, and which, if the medium expelling prohibition flag is not recorded in the nonvolatile storage, operates the removable medium loading/ejection mechanism to expel the medium according to the change in state of the switches or the command from the outside of the device.

According to the above-described arrangement, prohibition of expelling of the removable medium is controlled by using medium expelling prohibition information recorded in a predetermined area on the removable medium, and information indicating that the medium on which the medium expelling prohibition information is recorded exists in the device is stored in the nonvolatile storage in the device to prohibit expelling of the medium before determination as to whether or not the expelling prohibition information is recorded on the medium immediately after power-on of the device, thereby ensuring that the expelling prohibiting state is not canceled even after powering off the device, and that determination can be made as to whether or not each of mediums inserted in the device is allowed to be expelled by a user.

The removable medium loading/ejection mechanism is arranged to be incapable of forcibly expelling the removable medium during power-down of the device.

According to the above-described arrangement, forced expelling cannot be performed during power-down of the device, so that forced expelling of the medium using a forced expelling mechanism is prevented.

The controller clears the medium expelling prohibition flag in the nonvolatile storage when the medium expelling prohibition cancellation command from the outside of the device is received.

According to the above-described arrangement, the medium expelling prohibition flag in the nonvolatile storage is cleared when the medium expelling prohibition cancellation command from the outside of the device is received, and medium expelling prohibition before the medium is again inserted in the medium expelling prohibited device is canceled.

The medium expelling prohibition information includes a medium expelling prohibition cancellation code, and the controller accepts the medium expelling prohibition cancellation command as a valid command only if the medium expelling prohibition cancellation command includes the medium expelling prohibition cancellation code or data obtained by converting the medium expelling prohibition cancellation code by a certain rule.

According to the above-described arrangement, medium expelling prohibition is cancelled only when the medium expelling prohibition cancellation command including the medium expelling prohibition cancellation code included in the medium expelling prohibition information recorded on the removable medium or data obtained by converting the medium expelling prohibition cancellation code by a certain rule is received, and medium expelling prohibition before the medium is again inserted in the medium expelling prohibited device is canceled.

The removable medium loading/ejection mechanism has a forced expelling mechanism capable of forcibly expelling the medium during power-down of the device, and a forced expelling mechanism changer which mechanically changes the forced expelling mechanism between an inoperable state and an operable state. The controller operates to set the forced expelling mechanism in the inoperable state by controlling the forced expelling mechanism changer if the medium expelling prohibition information is recorded, and to set the forced expelling mechanism in the operable state by controlling the forced expelling mechanism changer if the medium expelling prohibition information is not recorded.

According to the above-described arrangement, control of removable medium expelling prohibition is performed along with the operation of the forced expelling mechanism by using the medium expelling prohibition information recorded in the predetermined area on the removable medium, thereby ensuring that the expelling prohibiting state is not canceled even after powering off the device, and that determination can be made as to whether or not each of mediums inserted in the device is allowed to be expelled by a user.

The forced expelling mechanism in the removable medium loading/ejection mechanism is arranged to forcibly expel the medium by inserting a pin into a hole provided in a front surface of the device during power-down of the device. The forced expelling mechanism changer of the removable medium loading/ejection mechanism is arranged to mechanically change the forced expelling mechanism between the inoperable state and the operable state by opening and closing the hole provided in the front surface of the device.

According to the above-described arrangement, the forced expelling mechanism in the removable medium loading/ejection mechanism is mechanically changed between the inoperable state and the operable state by opening and closing the hole provided in the front surface of the device.

Also, the forced expelling mechanism in the removable medium loading/ejection mechanism is arranged to forcibly expel the medium by inserting the pin into the hole provided in the front surface of the device during power-down of the device and by pressing a forced expelling lever interlocked with the loading/ejection mechanism with the pin. The forced expelling mechanism changer of the removable medium loading/ejection mechanism is arranged to selectively change the forced expelling lever between a position at which the medium can be forcibly expelled by inserting the pin into the hole and a position at which the medium cannot be forcibly expelled by inserting the pin into the hole.

According to the above-described arrangement, the forced expelling mechanism in the removable medium loading/ejection mechanism selectively changes the forced expelling lever between a position at which the medium can be forcibly expelled by inserting the pin into the hole and a position at which the medium cannot be forcibly expelled by inserting the pin into the hole.

According to the present invention, there is also provided a medium expelling control method for a removable medium recording/reproduction device having a removable medium loading/ejection mechanism which operates according to a change in state of switches each provided on an outer portion or on an inner portion of the device or according to a command from the outside of the device to transport a removable medium into the device and to set the removable medium in a reproducible state or to transport and expel the removable medium out of the device, the method including determining whether or not medium expelling prohibition information is recorded in a predetermined area on the removable medium, not performing expelling of the medium due to a change in state of the switches or a command from the outside of the device if it is determined that the medium expelling prohibition information is recorded, and operating the removable medium loading/ejection mechanism to expel the medium according to the change in state of the switches or the command from the outside of the device if it is determined that the medium expelling prohibition information is not recorded.

According to the above-described method, prohibition of expelling of the removable medium is controlled by using medium expelling prohibition information recorded in a predetermined area on the removable medium, thereby ensuring that the expelling prohibiting state is not canceled even during power-down of the device, and that determination can be made as to whether or not each of mediums inserted into the device is allowed to be expelled by a user.

There is also provided another medium expelling control method for a removable medium recording/reproduction device having a removable medium loading/ejection mechanism which operates according to a change in state of switches each provided on an outer portion or on an inner portion of the device or according to a command from the outside of the device to transport a removable medium into the device and to set the removable medium in a reproducible state or to transport and expel the removable medium out of the device, the method including not performing expelling of the medium due to a change in state of the switches or a command from the outside of the device if it is determined that detection as to whether or not a removable medium exists in the device is being performed, if it is determined that detection as to whether or not medium expelling prohibition information is recorded in a predetermined area on the removable medium is being performed, or if it is determined that the medium expelling prohibition information is recorded, and operating the removable medium loading/ejection mechanism to expel the medium according to the change in state of the switches or the command from the outside of the device if it is determined that removable medium exists in the device, and if it is determined that the medium expelling prohibition information is not recorded on the removable medium.

According to the above-described method, prohibition of expelling of the removable medium is controlled by using medium expelling prohibition information recorded in a predetermined area on the removable medium, and expelling of the removable medium is prohibited during detection as to the existence/nonexistence of the removable medium, or before determination as to whether or not medium expelling prohibition information is recorded on the medium, thereby ensuring that expelling of the medium is prevented immediately after power-on of the device, that the expelling prohibiting state is not cancelled even during power-down of the device, and that determination can be made as to whether or not each of mediums inserted into the device is allowed to be expelled by a user.

The method further includes canceling medium expelling prohibition when a medium expelling prohibition cancellation command is received from the outside of the device, and expelling the medium according to the change in state of all the switches or the command from the outside of the device in the time period from the cancellation of the medium expelling prohibition to detection of a record of the medium expelling prohibition information in the predetermined area on the removable medium performed upon reinsertion of the removable medium into the device.

According to the above-described method, medium expelling prohibition is canceled after the reception of a medium expelling prohibition cancellation command, and the canceled state is maintained before the medium is again inserted in the device, and before the record of the medium expelling prohibition information in the predetermined area on the medium is detected.

The medium expelling prohibition information includes a medium expelling prohibition cancellation code, and the method further includes making determination as to whether or not the medium expelling prohibition cancellation command includes the medium expelling prohibition cancellation code or data obtained by converting the medium expelling prohibition cancellation code by a certain rule, and accepting the medium expelling prohibition cancellation command as a valid command if it is determined that the medium expelling prohibition cancellation command includes the medium expelling prohibition cancellation code or the data.

According to the above-described method, medium expelling prohibition is cancelled only when the medium expelling prohibition cancellation command including the medium expelling prohibition cancellation code included in the medium expelling prohibition information recorded on the removable medium or data obtained by converting the medium expelling prohibition cancellation code by a certain rule is received, and the canceled state is maintained before the medium is again inserted in the device, and before the record of the medium expelling prohibition information in the predetermined area on the medium is detected.

There is provided still another medium expelling control method for a removable medium recording/reproduction device having a removable medium loading/ejection mechanism which operates according to a change in state of switches each provided on an outer portion or on an inner portion of the device or according to a command from the outside of the device to transport a removable medium into the device and to set the removable medium in a reproducible state or to transport and expel the removable medium out of the device, and a nonvolatile storage, the method including determining whether or not medium expelling prohibition information is recorded in a predetermined area on the removable medium, recording a medium expelling prohibition flag in the nonvolatile storage when the medium expelling prohibition information detector detects a record of medium expelling prohibition information, making determination as to whether or not the medium expelling prohibition flag is recorded in the nonvolatile storage, not performing expelling of the medium due to a change in state of the switches or a command from the outside of the device if it is determined that the medium expelling prohibition flag is recorded in the nonvolatile storage, and operating the removable medium loading/ejection mechanism to expel the medium according to the change in state of the switches or the command from the outside of the device if it is determined that the medium expelling prohibition flag is not recorded in the nonvolatile storage.

According to the above-described method, prohibition of expelling of the removable medium is controlled by using medium expelling prohibition information recorded in a predetermined area on the removable medium, information indicating that the medium on which the medium expelling prohibition information is recorded exists in the device is stored in the nonvolatile storage in the device to prohibit expelling of the medium before determination as to whether or not the expelling prohibition information is recorded on the medium immediately after power-on of the device, thereby ensuring that the expelling prohibiting state is not canceled even after powering off the device, and that determination can be made as to whether or not each of mediums inserted in the device is allowed to be expelled by a user.

The method further includes clearing the medium expelling prohibition flag in the nonvolatile storage when the medium expelling prohibition cancellation command from the outside of the device is received.

According to the above-described method, the information stored in the nonvolatile storage is cleared when the medium expelling prohibition cancellation command from the outside of the device is received, and the cancelled state is maintained before the medium is again inserted in the device, and before the record of the medium expelling prohibition information in the predetermined area on the medium is detected.

The medium expelling prohibition information includes a medium expelling prohibition cancellation code, and the method further includes making determination as to whether or not the medium expelling prohibition cancellation command includes the medium expelling prohibition cancellation code or data obtained by converting the medium expelling prohibition cancellation code by a certain rule, and accepting the medium expelling prohibition cancellation command as a valid command if it is determined that the medium expelling prohibition cancellation command includes the medium expelling prohibition cancellation code or the data.

According to the above-described method, the information stored in the nonvolatile storage is cleared only when the medium expelling prohibition cancellation command including the medium expelling prohibition cancellation code included in the medium expelling prohibition information recorded on the removable medium or data obtained by converting the medium expelling prohibition cancellation code by a certain rule is received, and medium expelling prohibition before the medium is again inserted in the medium expelling prohibited device is canceled.

The removable medium loading/ejection mechanism has a forced expelling mechanism capable of forcibly expelling the medium during power-down of the device, and a forced expelling mechanism changer which mechanically changes the forced expelling mechanism between an inoperable state and an operable state, the method further including setting the forced expelling mechanism in the inoperable state by controlling the forced expelling mechanism changer not to perform expelling of the medium due to the change in state of the switches or the command from the outside of the device, and setting the forced expelling mechanism in the operable state by controlling the forced expelling mechanism changer to operate the removable medium loading/ejection mechanism so as to expel the medium according to the change in state of the switches or the command from the outside of the device.

According to the above-described method, control of removable medium expelling prohibition is performed along with the operation of the forced expelling mechanism by using the medium expelling prohibition information recorded in the predetermined area on the removable medium, thereby ensuring that the expelling prohibiting state is not canceled even after powering off the device, and that determination can be made as to whether or not each of mediums inserted in the device is allowed to be expelled by a user.

There is also provided a medium expelling control method for an information processing apparatus having a removable medium loading/ejection mechanism which operates according to a change in state of switches each provided on an outer portion or on an inner portion of the apparatus or according to a command from the outside of the apparatus to transport a removable medium into the apparatus and to set the removable medium in a reproducible state or to transport and expel the removable medium out of the apparatus, a controller which reads out data from the removable medium or records data on the removable medium, and which processes data read out from the removable medium, and an input device for enabling a user to operate the controller as desired, the method including determining whether or not medium expelling prohibition information is recorded in a predetermined area on the removable medium, not performing expelling of the medium due to a change in state of the switches or a command from the input device if it is determined that the medium expelling prohibition information is recorded, and operating the removable medium loading/ejection mechanism to expel the medium according to the change in state of the switches or the command from the input device if it is determined that the medium expelling prohibition information is not recorded.

According to the above-described method, prohibition of expelling of the removable medium is controlled by using medium expelling prohibition information recorded in a predetermined area on the removable medium, thereby ensuring that the expelling prohibiting state is not canceled even during power-down of the apparatus, and that determination can be made as to whether or not each of mediums inserted into the apparatus is allowed to be expelled by a user.

There is also provided another removable medium expelling control method for an information processing apparatus having a removable medium loading/ejection mechanism which operates according to a change in state of switches each provided on an outer portion or on an inner portion of the apparatus or according to a command from the outside of the apparatus to transport a removable medium into the apparatus and to set the removable medium in a reproducible state or to transport and expel the removable medium out of the apparatus, a controller which reads out data from the removable medium or records data on the removable medium, and which processes data read out from the removable medium, and an input device for enabling a user to operate the controller as desired, the method including not performing expelling of the medium due to a change in state of the switches or a command from the outside of the apparatus if it is determined that detection as to whether or not a removable medium exists in the apparatus is being performed, if it is determined that detection as to whether or not medium expelling prohibition information is recorded in a predetermined area on the removable medium is being performed, or if it is determined that the medium expelling prohibition information is recorded, and operating the removable medium loading/ejection mechanism to expel the medium according to the change in state of the switches or the command from the outside of the apparatus if it is determined that removable medium exists in the apparatus, and if it is determined that the medium expelling prohibition information is not recorded on the removable medium.

According to the above-described method, prohibition of expelling of the removable medium is controlled by using medium expelling prohibition information recorded in a predetermined area on the removable medium, and expelling of the removable medium is prohibited during detection as to the existence/nonexistence of the removable medium in the apparatus, or before determination as to whether or not medium expelling prohibition information is recorded on the medium, thereby ensuring that expelling of the medium is prevented immediately after power-on of the apparatus, that the expelling prohibiting state is not cancelled even during power-down of the apparatus, and that determination can be made as to whether or not each of mediums inserted into the apparatus is allowed to be expelled by a user.

The method further includes canceling medium expelling prohibition by a certain operation on the input device, and expelling the medium according to the change in state of all the switches or the command from the outside of the apparatus in the time period from the cancellation of the medium expelling prohibition to detection of a record of the medium expelling prohibition information in the predetermined area on the removable medium performed upon reinsertion of the removable medium into the apparatus.

According to the above-described method, medium expelling prohibition is canceled after the reception of a medium expelling prohibition cancellation command by a certain operation on the input device, and the canceled state is maintained before the medium is again inserted in the apparatus, and before the record of the medium expelling prohibition information in the predetermined area on the medium is detected.

The medium expelling prohibition information includes a medium expelling prohibition cancellation code, and the method further includes, when an input including the medium expelling prohibition cancellation code or data obtained by converting the medium expelling prohibition cancellation code by a certain rule is provided as a medium expelling prohibition cancellation command by an operation on the input device, accepting the medium expelling prohibition cancellation command as a valid command.

According to the above-described method, medium expelling prohibition is cancelled only when the medium expelling prohibition cancellation command including the medium expelling prohibition cancellation code included in the medium expelling prohibition information recorded on the removable medium or data obtained by converting the medium expelling prohibition cancellation code by a certain rule is received, and the canceled state is maintained before the medium is again inserted in the apparatus, and before the record of the medium expelling prohibition information in the predetermined area on the medium is detected.

The method further includes recording the medium expelling prohibition information in the predetermined area on the recordable removable medium by an operation on the input device.

According to the above-described method, the medium expelling prohibition information is recorded in the predetermined area on the removable medium by an operation on the input device, thereby ensuring that removable medium expelling prohibition can be controlled according this medium expelling prohibition information.

The method further includes generating a medium expelling prohibition cancellation code obtained by inputting a sequence of characters by an operation on the input device or by converting the input sequence of characters by a certain rule; recording medium expelling prohibition information including the generated medium expelling prohibition cancellation code in the predetermined area on the recordable removable medium; when the medium expelling prohibiting state is canceled by an operation on the input device, canceling the medium expelling prohibition if an input including the medium expelling prohibition cancellation code or data obtained by converting the medium expelling prohibition cancellation code by a certain rule is provided; and expelling the medium according to a change in state of all the switches or a command from the input device in the time period from the cancellation of the medium expelling prohibition to detection of a record of the medium expelling prohibition information in the predetermined area on the medium performed upon reinsertion of the removable medium into the apparatus.

According to the above-described method, medium expelling prohibition is cancelled only when the medium expelling prohibition information including the medium expelling prohibition cancellation code generated by an operation on the input device is recorded in the predetermined area on the removable medium, and when the medium expelling prohibition cancellation command including the medium expelling prohibition cancellation code is received, and the canceled. state is maintained before the medium is again inserted in the apparatus, and before the record of the medium expelling prohibition information in the predetermined area on the medium is detected.

The method further includes forcibly recording the medium expelling prohibition information in the predetermined area on the removable medium when data is recorded on the removable medium, and setting the apparatus in a medium expelling prohibiting state after the completion of the recording.

According to the above-described method, the medium expelling prohibition information is forcibly recorded when data is recorded on the removable medium, thereby ensuring that taking out of data from the information processing apparatus to the outside by means of the removable medium is restricted.

There is also provided another medium expelling control method for an information processing apparatus having a removable medium loading/ejection mechanism which operates according to a change in state of switches each provided on an outer portion or on an inner portion of the apparatus or according to a command from the outside of the apparatus to transport a removable medium into the apparatus and to set the removable medium in a reproducible state or to transport and expel the removable medium out of the apparatus, a nonvolatile storage, a controller which reads out data from the removable medium or records data on the removable medium, and which executes data read out from the removable medium, and an input device for enabling a user to operate the controller as desired, the method including determining whether or not medium expelling prohibition information is recorded in a predetermined area on the removable medium; recording a medium expelling prohibition flag in the nonvolatile storage if it is determined that medium expelling prohibition information is recorded; determining whether or not the medium expelling prohibition flag is recorded in the nonvolatile storage; not performing expelling of the medium due to a change in state of the switches or a command from the input device if it is determined that the medium expelling prohibition flag is recorded in the nonvolatile storage; and operating the removable medium loading/ejection mechanism to expel the medium according to the change in state of the switches or the command from the input device if it is determined that the medium expelling prohibition flag is not recorded in the nonvolatile storage.

According to the above-described method, prohibition of expelling of the removable medium is controlled by using medium expelling prohibition information recorded in a predetermined area on the removable medium, and information indicating that the medium on which the medium expelling prohibition information is recorded exists in the apparatus is stored in the nonvolatile storage in the apparatus to prohibit expelling of the medium before determination as to whether or not the expelling prohibition information is recorded on the medium immediately after power-on of the apparatus, thereby ensuring that the expelling prohibiting state is not canceled even after powering off the apparatus, and that determination can be made as to whether or not each of mediums inserted in the apparatus is allowed to be expelled by a user.

The method further includes canceling medium expelling prohibition by a certain operation on the input device, and clearing the medium expelling prohibition flag in the nonvolatile storage when the medium expelling prohibition is canceled.

According to the above-described method, the information stored in the nonvolatile storage is cleared when the medium expelling prohibition cancellation command is received by a certain operation on the input device, and medium expelling prohibition is cancelled before the medium is again inserted into the apparatus, and before the record of the medium expelling prohibition information in the predetermined area on the medium is detected.

The medium expelling prohibition information includes a medium expelling prohibition cancellation code, and the method further includes, when an input including the medium expelling prohibition cancellation code or data obtained by converting the medium expelling prohibition cancellation code by a certain rule is provided as a medium expelling prohibition cancellation command by an operation on the input device, accepting the medium expelling prohibition cancellation command as a valid command.

According to the above-described method, information stored in the nonvolatile storage is cleared only when the medium expelling prohibition cancellation command including the medium expelling prohibition cancellation code included in the medium expelling prohibition information recorded on the removable medium or data obtained by converting the medium expelling prohibition cancellation code by a certain rule is received, and medium expelling prohibition is cancelled before the medium is again inserted into the apparatus, and before the record of the medium expelling prohibition information in the predetermined area on the medium is detected.

The method further includes recording the medium expelling prohibition information in the predetermined area on the recordable removable medium by an operation on the input device, and recording the medium expelling flag in the nonvolatile storage.

According to the above-described method, removable medium expelling prohibition is controlled by recording medium expelling prohibition information in the predetermined area of the removable medium, and information indicating that the medium expelling prohibition information has been recorded or that the medium on which the medium expelling prohibition information is recorded exists in the apparatus is stored in the nonvolatile storage in the apparatus to prohibit expelling of the medium before determination as to whether or not the expelling prohibition information is recorded on the medium immediately after power-on of the apparatus.

The method further includes generating a medium expelling prohibition cancellation code obtained by inputting a sequence of characters by an operation on the input device or by converting the input sequence of characters by a certain rule; recording medium expelling prohibition information including the generated medium expelling prohibition cancellation code in the predetermined area on the recordable removable medium, and recording the medium expelling prohibition flag in the nonvolatile storage; making determination as to whether or not an input including the medium expelling prohibition cancellation code or data obtained by converting the medium expelling prohibition cancellation code by a certain rule has been provided as a medium expelling prohibition cancellation command; clearing the medium expelling prohibition flag in the nonvolatile storage if it is determined that an input including the medium expelling prohibition cancellation code or data obtained by converting the medium expelling prohibition cancellation code by a certain rule has been provided.

According to the above-described method, medium expelling prohibition information is recorded in the predetermined area on the removable medium; information indicating that the medium on which the medium expelling prohibition information is recorded exists in the apparatus is stored in the nonvolatile storage in the apparatus; and expelling of the medium is prohibited even during the time period before determination as to whether or not the medium expelling prohibition information is recorded on the medium immediately after powering on the apparatus. Also, the information stored in the nonvolatile storage is cleared only when the medium expelling prohibition cancellation command including the medium expelling prohibition cancellation code included in the medium expelling prohibition information recorded on the removable medium or data obtained by converting the medium expelling prohibition cancellation code by a certain rule is received, and medium expelling prohibition is cancelled before the medium is again inserted into the apparatus, and before the record of the medium expelling prohibition information in the predetermined area on the medium is detected.

The method further includes forcibly recording the medium expelling prohibition information in the predetermined area on the removable medium when data is recorded on the removable medium, and setting the apparatus in a medium expelling prohibiting state after the completion of the recording.

According to the above-described method, medium expelling prohibition information is forcibly recorded when data is recorded on the removable medium, thereby ensuring that taking out of the data from the inside of the information processing apparatus to the outside by means of the removable medium is restricted.

The removable medium loading/ejection mechanism has a forced expelling mechanism capable of forcibly expelling the medium during power-down of the apparatus, and a forced expelling mechanism changer which mechanically changes the forced expelling mechanism between an inoperable state and an operable state, and the method further includes setting the forced expelling mechanism in the inoperable state by controlling the forced expelling mechanism changer not to expel the medium according to the change in state of the switches or the command from the input device, and setting the forced expelling mechanism in the operable state by controlling the forced expelling mechanism changer to operate the removable medium loading/ejection mechanism so as to expel the medium according to the change in state of the switches or the command from the input device.

According to the above-described method, control of removable medium expelling prohibition is performed along with the operation of the forced expelling mechanism by using medium expelling prohibition information recorded in the predetermined area on the removable medium, thereby ensuring that the expelling prohibiting state is not canceled even after powering off the apparatus, and that determination can be made as to whether or not each of mediums inserted in the apparatus is allowed to be expelled by a user.

### ADVANTAGES OF THE INVENTION

The removable medium recording/reproduction device of the present invention is arranged as described above and controls removable medium expelling prohibition by using medium expelling prohibition information recorded in the predetermined area on the removable medium, thereby ensuring that the expelling prohibiting state of the device is not canceled even during power-down of the device, and that determination can be made as to whether each of mediums inserted into the device is allowed to be expelled by a user.

### BRIEF DESCRIPTION OF THE DRAWINGS

FIG. 1 is a block diagram showing an application of a removable medium recording/reproduction device and information processing apparatus in Embodiment 1 of the present invention to an information processing apparatus constituted by a CD-R/RW recording/reproduction device and a host computer;

FIG. 2 is a flowchart showing the flow of medium recognition processing and the flow of medium expelling processing in the removable medium recording/reproduction device in Embodiment 1 of the present invention;

FIG. 3 is a flowchart showing the flow of processing for canceling medium expelling prohibition in the removable medium recording/reproduction device in Embodiment 1 of the present invention;

FIG. 4 is a flowchart showing processing for recording medium expelling prohibition information on the removable medium in Embodiment 1 of the present invention;

FIG. 5 is a block diagram of an application of a removable medium recording/reproduction device in Embodiment 2 of the present invention to a CD-R/RW recording/reproduction apparatus;

FIGS. 6A and 6B are flowcharts respectively showing a flow of medium recognition processing and a flow of medium expelling processing in the removable medium recording/reproduction device in Embodiment 2 of the present invention;

FIG. 7 comprises an appearance view of a device provided by applying a removable medium recording/reproduction device in Embodiment 3 of the present invention to a CD-R/RW recording/reproduction device, and diagrams showing an example of a mechanism for selecting between operability and inoperability of a mechanism for forcibly expelling a medium; and

FIG. 8 is a flowchart showing processing for recording data on a removable medium in Embodiment 4 of the present invention.

### BEST MODE FOR CARRYING OUT THE INVENTION

Embodiments of the present invention will be described with reference to the drawings.

### EMBODIMENT 1

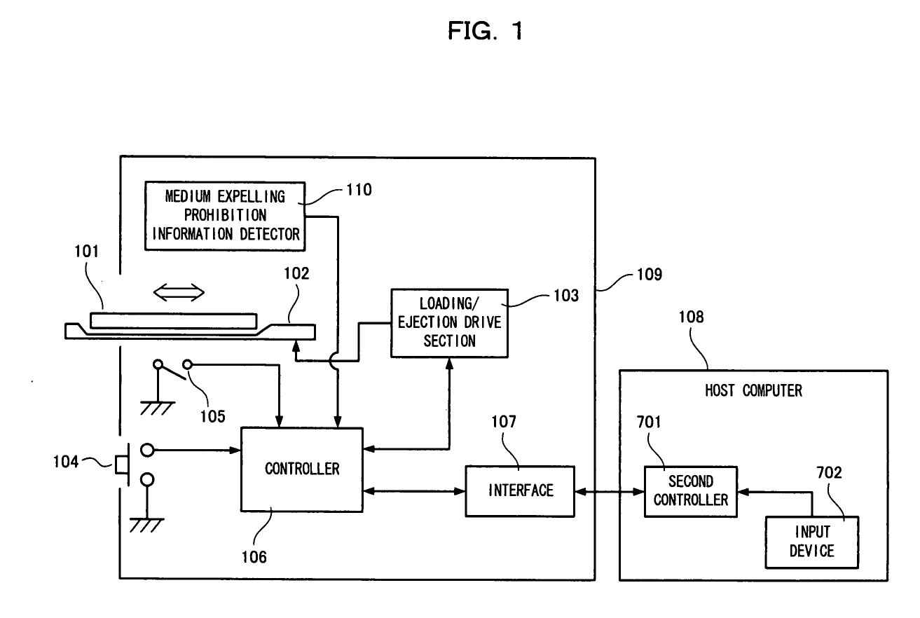

Embodiment 1 of the present invention will be described below with reference to FIGS. 1 to 4.

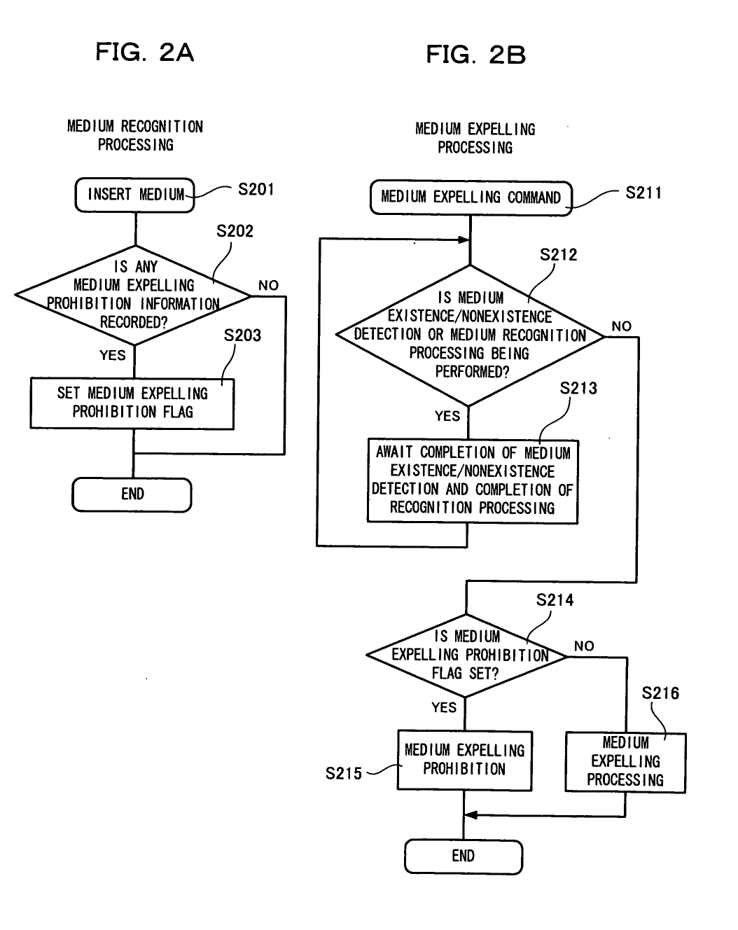

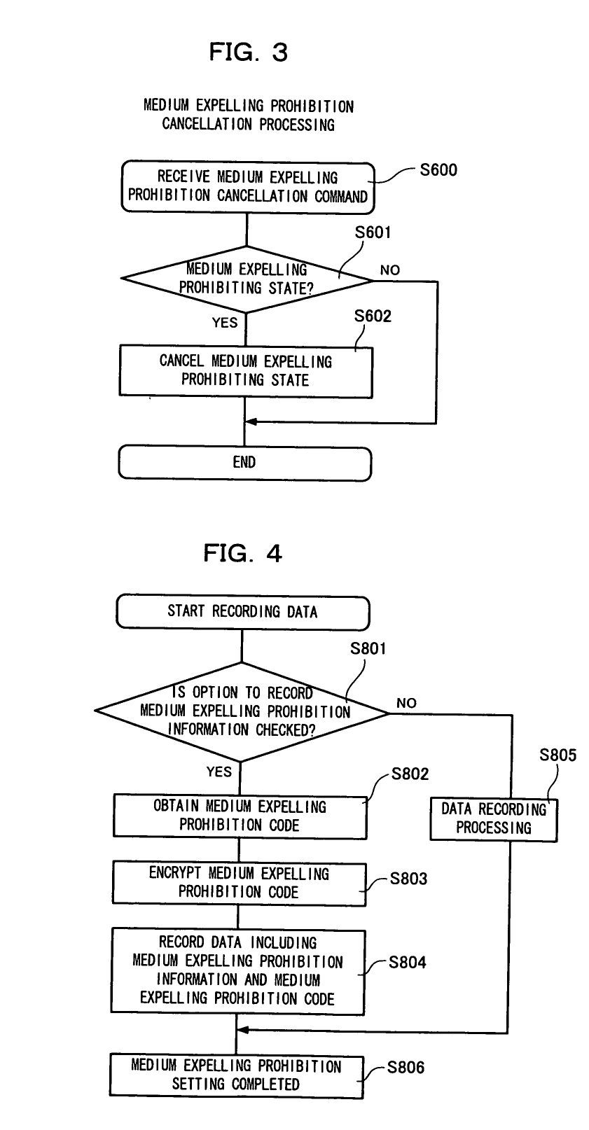

FIG. 1 is a block diagram of an information processing apparatus constituted by a CD-R/RW recording/reproduction device (an example of the removable medium recording/reproduction device) and a host computer in Embodiment 1 of the present invention. FIG. 2 is a flowchart showing the flow of medium recognition processing and the flow of medium expelling processing in accordance with the present invention. FIG. 3 is a flowchart showing the flow of medium expelling prohibition cancellation processing in accordance with the present invention. FIG. 4 is a flowchart showing the flow of medium expelling prohibition information recording processing for recording medium expelling prohibition information on a removable medium in accordance with the present invention.

Referring to FIG. 1, reference numeral 101 denotes a removable medium (CD-ROM/R/RW disk in this embodiment, hereinafter referred to simply as “medium”). A medium having medium expelling prohibition information recorded in its predetermined region and a medium having no such information exist as removable medium 101. Reference numeral 102 denotes a medium transporter which has the medium 101 mounted thereon and performs an operation to transport the medium 101 to a reproducible position, or an operation to expel the medium 101. A case where the medium transporter 102 is a tray capable of mounting the medium 101 and performing an operation to transport the medium 101 to a reproducible position or an operation to expel the medium 101 will be described in the description of this embodiment. Reference numeral 103 denotes a loading/ejection drive section which performs an operation to load or eject the medium 101 by driving the medium transporter 102. The loading/ejection drive section 103 drives the medium transporter 102, for example, by means of a combination of components including a motor, a gear, a belt and a solenoid to perform the operation to load or eject the medium 101. The loading/ejection drive section 103 is arranged to detect the existence/nonexistence of the medium 101 on the tray (the existence/nonexistence of the medium 101 in the device) at the time of power-on the device (including repower-on after powering off), at the time of resetting the device 109 or at the time of returning of the tray to the reproducible position by driving the medium transporter 102. In the process of detecting the existence/nonexistence of the medium 101, the loading/ejection drive section 103 outputs a medium existence/nonexistence under detection signal to a controller 106 and outputs information on the result of detection of the existence/nonexistence (medium detection information) to the controller 106. The medium transporter 102 and the loading/ejection drive section 103 constitute a loading/ejection mechanism which is operated by a change in state of a switch (described below) provided outside or inside the device or by a command supplied from the outside of the device to transport the medium 101 into the device and mount the medium 101 in a reproducible state or to expel the medium 101 by transporting the medium 101 to the outside of the device. The loading/ejection drive section 103 constitutes a removable medium detector. The removable medium loading/ejection mechanism cannot forcefully eject the medium 101 during power-down of the device.

Reference numeral 104 denotes a switch provided on an outer portion of the device. Reference numeral 105 denotes a switch provided on an inner portion of the device to detect a state of the medium transporter 102 being pressed from the outside. The loading/ejection operation can be controlled according to a combination of the logics of these switches.

Denoted by 106 is a controller, for example, a processing unit such as a CPU which controls the loading/ejection mechanism according to a change in state of the switches 104 and 105 or a command from the outside of the device, i.e., a command sent from the host computer 108 via an interface 107, to load or eject the removable medium 101, or to control reproduction/recording on the removable medium 101.

Reference numeral 110 denotes a medium expelling prohibition information detector which detects whether or not medium expelling prohibition information is recorded in an area set in advance on the removable medium l01 when the removable medium 101 is transported to the reproducible position by the medium transporter 102 (when the medium is inserted in the device by the loading/ejection mechanism). Information detected by the medium expelling prohibition information detector 110 is output to the controller 106. Examples of a method of recording the medium expelling prohibition information include, for a CD-ROM/R/RW disk for example, a method in which the information is recorded in a particular channel for subcode information (an example of the area set in advance) such that the data recording capacity of the main portion is not reduced, and a method of recording the information as a portion of TOC data. An example of a method of recording medium expelling prohibition information conceivable with respect to a non-disk medium is a method of recording and using a predetermined address portion in a portion of a recording area. An example of a method of recording medium expelling prohibition information conceivable with respect to other disk mediums and non-disk mediums is a method of recording the information on a chip embedded in the medium. A method of reading medium expelling prohibition information by means of a wireless device or some other device is conceivable.

Reference numeral 109 denotes the entire removable medium recording/reproduction device (CD-R/RW recording/reproduction device).

Reference numeral 701 denotes a second controller of the host computer 108. Reference numeral 702 denotes an input device of the host computer 108. The second controller 701 is a central processor, e.g., a CPU or the like. The second controller 701 perform operations including operations to execute various kinds of processing according to inputs from the input device 702, operations to perform various kinds of processing by sending a command to the removable medium recording/reproduction device 109 and reading out data from the removable medium 101, and an operation to record data.

“Medium recognition processing and medium expelling processing”

A medium recognition processing operation and medium expelling processing performed by the above-described controller 106 will be described along with the actual operation with reference to FIG. 2.

An operation to perform medium recognition processing when the medium 101 is loaded into the removable medium recording/reproduction device 109 will first be described (see FIG. 2(a)).

Step-S201

The controller 106 controls the loading/ejection drive section 103 to drive the medium transporter 102 in response to depression of the switch 104 provided on an outer portion of the device or a change in state of the switch 105 provided on an inner portion of the device for detection of a state of the medium transporter 102 being pressed from the outside, or according to a medium loading command sent from the second controller 701 via the interface 107 in response to an operation on the input device 702 of the host computer 108, thereby transporting the removable medium 101 mounted on the medium transporter 102 into the device and setting the medium 101 in the reproducible position.

At this time, the loading/ejection drive section 103 detects the existence/nonexistence of the medium 101, outputs the medium (existence/nonexistence) under detection signal to the controller 106 during detection, and outputs a signal representing the result of detection of the existence/nonexistence (medium detection information) to the controller 106.

Step-S202

Subsequently, the controller 106 drives the medium expelling prohibition information detector 110 to detect whether or not medium expelling prohibition information is recorded on the removable medium 101 set in the reproducible position, and determines, from a signal representing the result of this detection, whether or not medium expelling prohibition information is recorded on the medium 101.

Step-S203

If the controller 106 determines in step-S202 that medium expelling prohibition information is recorded, it sets a medium expelling prohibition flag and terminates medium recognition processing. If the controller 106 determines in step-S202 that no medium expelling prohibition information is recorded, it immediately terminates medium recognition processing.

Description will next be made of the flow of medium expelling processing (see FIG. 2(b)).

Step-S211

The controller 106 first starts medium expelling processing by using as a trigger for a medium expelling command a medium ejection command sent from the second controller 701 via the interface 107 in response to depression of the switch 104 provided on an outer portion of the device or an operation on the input device 702 of the host computer 108.

Step-S212

The controller 106 determines whether or not the medium (existence/nonexistence) under detection signal is input from the loading/ejection drive section 103 or whether or not the above-described step-S202 or S203 is being executed (whether or not the above-described medium recognition processing is being performed).

Step-S213

If the controller 106 determines in the above-described step-S212 that the medium (existence/nonexistence) under detection signal is input or medium recognition processing is being performed, it awaits the completion of medium recognition processing in loop processing and does not execute medium expelling processing. This processing is for preventing the medium 101 on which medium expelling prohibition information is recorded from being expelled upon reception of the medium expelling command during the time period when detection of the existence/nonexistence of the medium 101 is being performed immediately after powering on the device, or during the time period from power-on to the completion of detection as to whether or not medium expelling prohibition information is recorded. Therefore, a method of canceling the medium expelling command and terminating processing during detection of (the existence/nonexistence of) the medium or medium recognition processing can also be applied as well as the method of awaiting the completion of medium recognition processing.

Step-S214

If the controller 106 determines in the above-described step-S212 that neither of detection of (the existence/nonexistence of) the medium and medium recognition processing is being performed, it determines whether or not the medium expelling prohibition flag is set.

Step-S215

If the controller 106 determines in step-S214 that the medium expelling prohibition flag is set, it cancels the medium expelling command and terminates the processing without executing medium expelling.

Step-S216

If the controller 106 determines in step-S214 that the medium expelling prohibition flag is not set, that is, no medium expelling prohibition information is recorded on the medium, it controls the loading/ejection drive section 103 to drive the medium transporter 102. The controller 106 thus performs and completes the processing for expelling the medium 101 mounted on the medium transporter 102.

The above-described medium recognition processing is also executed at the time of powering on the device (including repower-on after powering off) and at the time of resetting the device 109.

“Medium expelling prohibition cancellation processing”

An operation performed by the controller 106 to cancel medium expelling prohibition information will be described with reference to FIG. 3. Medium expelling prohibition is canceled ordinarily by the second controller 701 of the host computer 108 transmitting a medium expelling prohibition cancellation command to the removable medium recording/reproduction device 109 according to a certain operation on the input device 702. The medium expelling prohibition cancellation command is, for example, a set of a main command portion and a medium expelling prohibition cancellation code (or data obtained by converting a medium expelling prohibition cancellation code by a certain rule) The medium expelling prohibition cancellation command is recognized only when the medium expelling prohibition cancellation code coincides with a code stored on the medium 101 or a code identified by (or provided in) the removable medium recording/reproduction device 109. The medium expelling prohibition cancellation code is stored in advance as information proper to the device, for example, in a nonvolatile storage (not shown) in the removable medium recording/reproduction device 109. Alternatively, the medium expelling prohibition cancellation code is stored as a portion of medium expelling prohibition information on the medium 101. It is desirable from the viewpoint of security that the medium expelling prohibition cancellation code be recorded by encryption, interleave recording or the like in such a form as to be difficult to read out. The second controller 701 transmits the medium expelling prohibition cancellation command to the removable medium recording/reproduction device 109 according to an input signal from the input device 702.

Step-S600

When the controller 106 receives the valid medium expelling prohibition cancellation command from the ordinary host computer 108 via the interface circuit 107, it recognizes the received command as the medium expelling prohibition cancellation command (accepts the received command as a valid command) if the received command includes the medium expelling prohibition cancellation code, and if the medium expelling prohibition cancellation code coincides with the code provided in the removable medium recording/reproduction device 109.

Step-S601

Subsequently, the controller 106 determines whether or not the device is in the medium expelling prohibiting state.

Step-S602

If the controller 106 determines that the device is in the medium expelling prohibiting state, it performs and completes medium expelling prohibition cancellation processing by canceling the medium expelling prohibition flag.

Thus, the controller 106 checks the medium expelling prohibition cancellation code after receiving the medium expelling prohibition cancellation command sent from the host computer 108 via the interface circuit 107, turns off the medium expelling prohibition flag and executes medium expelling prohibition cancellation processing. The controller 106 expels the removable medium 101 according to a change in state of all the switches 104 and 105 or the next medium expelling command, e.g., a command supplied from the outside of the device in the time period from the reception of the medium expelling prohibition cancellation command from the outside of the device to the detection of a record of medium expelling prohibition information in the predetermined area on the medium 101 again performed by the medium expelling prohibition information detector 110 at the time of insertion of the medium 101 into the device.

The medium expelling prohibition cancellation state is effective only before the medium 101 is temporarily expelled, during the time period when the device is powered, or during the time period before the device is reset. When the medium 101 is temporarily expelled, or when a record of medium expelling prohibition information on the medium is detected during the medium recognition operation performed, for example, upon repower-on after power-down, or upon reset of the device, the device again enters the medium expelling prohibiting state.

“Medium Expelling Prohibition Information Recording Processing”

An operation performed by the second controller 701 to record medium expelling prohibition information on the medium 101 by a method of recording the information simultaneously with recording of certain data on the medium 101 will next be described by way of example with reference to FIG. 4.

In a piece of recording control software executed on the host computer 108, an option to record medium expelling prohibition information at the time of recording of certain data on the medium 101 can be selected by the input device 702 to be executed. When the option to record medium expelling prohibition information is selected, input of a medium expelling prohibition code is enabled. The medium expelling prohibition code is determined by being input by the input device 702. A user can input the medium expelling prohibition code to the input device 702. It is also possible to automatically generate the medium expelling prohibition code by using the recording control software. In such a case, the generated medium expelling prohibition code may he displayed on a display (not shown) of the host computer 108 to enable the user to obtain the method of canceling the medium expelling prohibiting state when required.

Step-S801

At the start of recording, the second controller 701 first determines whether or not the option to record medium expelling prohibition information has been selected.

Step-S802

If the second controller 701 determines that the option to record medium expelling prohibition information has been selected, it obtains the medium expelling prohibition code from the input device 702 or the recording control software.

Step-S803

Subsequently, the second controller 701 encrypts the obtained medium expelling prohibition code by a certain rule. Needless to say, it is not necessary to encrypt the medium expelling prohibition code in a case where the medium expelling prohibition code is recorded so that the code cannot be easily read, or in a case where the required security level is not so high.

Step-S804

Subsequently, the second controller 701 starts recording data. If the medium expelling prohibition information and the medium expelling prohibition code are embedded in subcode information at the time of recording in the CD-R/RW recording/reproduction device for example, the information and the code are recorded in the predetermined area on the medium 101 while being encoded along with the data to be recorded.

Step-S805

If the second controller 701 determines in step-S801 that the option to record medium expelling prohibition information has not been selected, it performs ordinary recording processing.

Step-S806

After completing the recording operation in step-S804 or S805, ordinarily the second controller 701 temporarily expel the medium 101 out of the device and terminates recording processing.

Thus, when certain data is recorded on the medium 101, medium expelling prohibition information is optionally recorded and the medium 101 is temporarily expelled out of the device. When the medium 101 is again loaded into the removable medium recording/reproduction device 109, the device 109 enters the medium expelling prohibiting state.

When medium expelling prohibition information is recorded on the medium 101, the above-described medium expelling prohibition cancellation code can be stored as a portion of the medium expelling prohibition information on the medium 101. At this time, the second controller 701 executes the step of generating a medium expelling prohibition cancellation code by inputting a sequence of characters input by an operation on the input device 702 or by converting the input sequence of characters by a certain rule, and the step of recording the medium expelling prohibition information including the generated medium expelling prohibition cancellation code in the predetermined recordable area on the medium 101. If, when the medium expelling prohibition condition is canceled by operating the input device 702, the above-described medium expelling prohibition cancellation code (or data obtained by converting the medium expelling prohibition cancellation code by a certain rule) is input, the second controller 701 executes the step of canceling medium expelling prohibition by the above-described medium expelling prohibition cancellation processing.

According to Embodiment 1 of the present invention, as described above, a removable medium recording/reproduction device, a medium expelling control method for the removable medium recording/reproduction device and a removable medium expelling control method for an information processing apparatus can be provided in which prohibition of expelling of the medium 101 is controlled by using medium expelling prohibition information recorded in a predetermined area on the medium 101, and expelling of the medium 101 is prohibited during detection of the existence/nonexistence of the medium 101 or before determination as to whether or not the expelling prohibition information is recorded on the medium immediately after power-on of the device, whereby it is ensured that expelling of the medium 101 immediately after power-on of the device can be prevented; the expelling prohibiting state is not canceled even after powering off the device; and determination can be made as to whether or not each of mediums inserted in the device is allowed to be expelled by a user.

According to Embodiment 1 of the present invention, a removable medium recording/reproduction device, a medium expelling control method for the removable medium recording/reproduction device and a removable medium expelling control method for an information processing apparatus can be provided in which the removable medium loading/ejection mechanism 103 of the removable medium recording/reproduction device 109 is arranged so that the medium 101 cannot be forcibly expelled during power-down or at the time of resetting of the device, whereby it is ensured that forced expelling of the medium 101 using the forced expelling mechanism can be prevented during power-down, and that it is difficult for any person other than the person who has set medium expelling prohibition to cancel medium expelling prohibition.

According to Embodiment 1 of the present invention, a removable medium recording/reproduction device, a medium expelling control method for the removable medium recording/reproduction device and a removable medium expelling control method for an information processing apparatus can be provided in which the removable medium 101 is inserted in the device only when a medium expelling prohibition cancellation command including a medium expelling prohibition cancellation code included in medium expelling prohibition information recorded in a predetermined area on the medium 101 is received, and medium expelling prohibition is canceled during the time period from the insertion of the medium 101 into the device to the detection of the record of the medium expelling prohibition information in the predetermined area on the medium, whereby it is ensured that the expelling prohibiting state is not canceled even after powering off the device; determination as to whether or not each of mediums inserted in the device is allowed to be expelled by a user; and it is difficult for any person other than the person who has set medium expelling prohibition to cancel medium expelling prohibition.

Embodiment 1 of the present invention has been described by way of example with respect to a case where medium expelling prohibition information and a medium expelling prohibition code are recorded together with data by being embedded in subcode information in a CD-R/RW recording/reproduction device. However, the present invention can be implemented in a similar manner by using any other method of recording in a readable area on a medium, e.g., a method of recording in a portion of TOC information on a CD-R/RW, a method of recording in a special-purpose area provided on a different kind of medium, or a method of recording in an area other than the ordinary data recording area, e.g., a nonvolatile memory area on a medium on which an IC chip or the like is mounted.

Embodiment 1 of the present invention has been described by way of example with respect to a case where the medium 101 is temporarily expelled out of the device after the completion of the recording operation. However, the present invention can be implemented in a similar manner without expelling the medium 101. In such a case, the invention can be implemented by using either of a method in which medium expelling prohibition is not effectuated before the medium is temporarily expelled and a method of setting the medium expelling prohibition flag to prohibit expelling at the point in time at which recording of medium expelling prohibition information is completed.

### EMBODIMENT 2

Description will be made of Embodiment 2 with reference to FIGS. 3 to 6. The same components as those of Embodiment 1 described above are indicated by the same reference numerals and the description for them will not be repeated. Also, the flow of medium expelling prohibition cancellation processing (FIG. 3) and the flow of medium expelling prohibition information recording processing (FIG. 4) are the same as those in Embodiment 1 and the description for them will not be repeated.

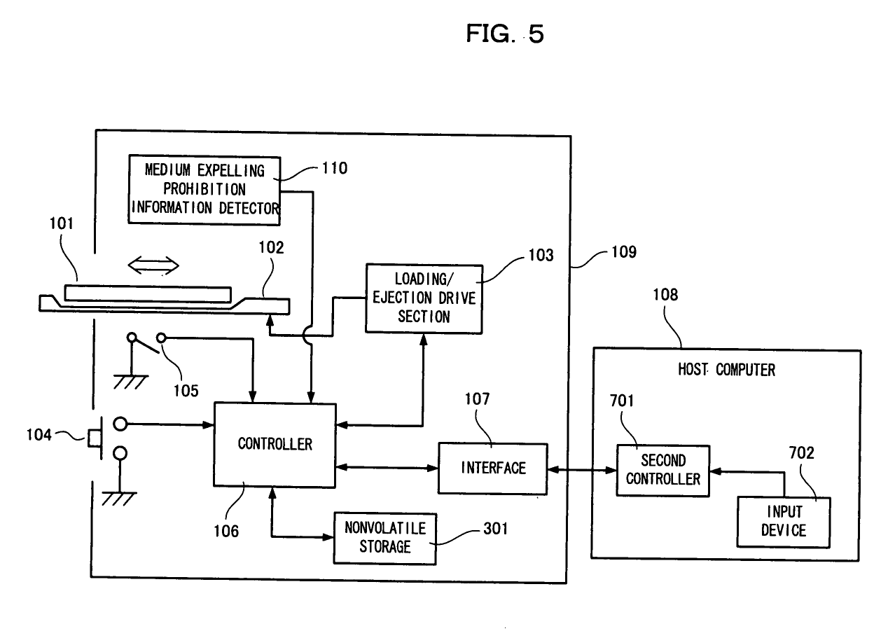

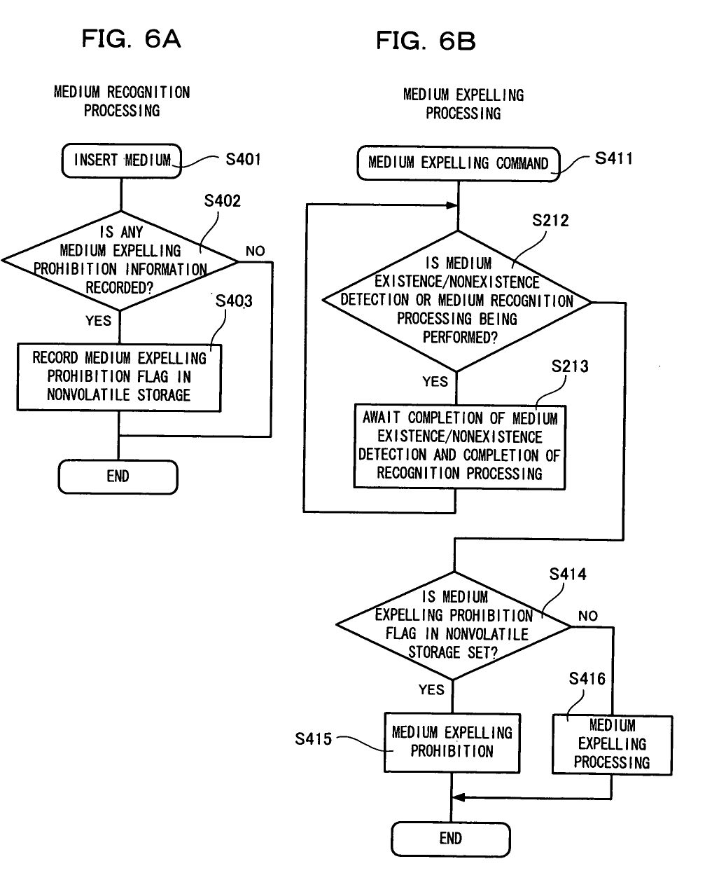

FIG. 5 is a block diagram of an application of the present invention to an information processing apparatus constituted by a CD-R/RW recording/reproduction apparatus. FIGS. 6A and 6B are flowcharts respectively showing a flow of medium recognition processing and a flow of medium expelling processing in accordance with the present invention.

As shown in FIG. 5, a nonvolatile storage 301 is newly provided in the removable medium recording/reproduction apparatus 109. For example, a control program for the controller 106 and various sorts of data are stored in the nonvolatile storage 301, and an area for recording the medium expelling prohibition flag is provided in the nonvolatile storage 301 in advance.

“Medium Recognition Processing and Medium Expelling Processing”

A medium recognition processing operation and a medium expelling processing performed by the controller 106 in Embodiment 2 will be described along with the actual operation with reference to FIGS. 6A and 6B (see FIG. 6A).

An operation to perform medium recognition processing when the medium 101 is loaded into the removable medium recording/reproduction device 109 will first be described.

Step-S401

The controller 106 controls the loading/ejection drive section 103 to drive the medium transporter 102 in response to depression of the switch 104 provided on an outer portion of the device or a change in state of the switch 105 provided on an inner portion of the device, or according to a medium loading command sent from the second controller 701 via the interface 107 in response to an operation on the input device 702 of the host computer 108, there by transporting the removable medium 101 mounted on the medium transporter 102 into the device and setting the medium 101 in the reproducible position.

Step-S402

Subsequently, the controller 106 drives the medium expelling prohibition information detector 110 to detect whether or not medium expelling prohibition information is recorded on the removable medium 101 set in the reproducible position, and determines, from a signal representing the result of this detection, whether or not medium expelling prohibition information is recorded on the removable medium 101.

Step-S403

If the controller 106 determines in step-S402 that medium expelling prohibition information is recorded, it records a medium expelling prohibition flag in the nonvolatile storage 301 and terminates medium recognition processing. If the controller 106 determines in step-S402 that no medium expelling prohibition information is recorded, it immediately terminates medium recognition processing. The medium expelling prohibition flag recorded in the nonvolatile storage 301 is held even during power-down of the device. The medium expelling prohibition flag also contains information indicating the existence of the removable medium 101 in the device.

Description will next be made of the flow of medium expelling processing.

Step-S411

The controller 106 first starts medium expelling processing by using as a trigger for a medium expelling command a medium ejection command sent from the second controller 701 via the interface 107 in response to depression of the switch 104 provided on an outer portion of the device or an operation on the input device 702 of the host computer 108.

Steps-S112 and S113 are then executed as in Embodiment 1.

Step-S414

If the controller 106 determines that neither of detection of (the existence/nonexistence of) the medium and medium recognition processing is being performed, it determines whether or not the medium expelling prohibition flag is set in the nonvolatile storage 301.

Step-S415

If the controller 106 determines in step-S414 that the medium expelling prohibition flag is set in the nonvolatile storage 301, that is, medium expelling prohibition information is recorded on the medium 101, it cancels the medium expelling command and terminates the processing without executing medium expelling.

Step-S416

If the controller 106 determines in step-S414 that the medium expelling prohibition flag is not set in the nonvolatile storage 301, that is, no medium expelling prohibition information is recorded in the nonvolatile storage 310 for the medium 101, it controls the loading/ejection drive section 103 to drive the medium transporter 102. The controller 106 thus performs and completes the processing for expelling the removable medium 101 mounted on the medium transporter 102.

When the controller 106 receives a medium expelling prohibition cancellation command sent from the second controller 701 via the interface 107 according to an operation on the input device 702 of the host computer 108, it clears the medium expelling prohibition flag stored in the nonvolatile storage 301 to cancel medium expelling prohibition, as in “medium expelling prohibition cancellation processing” in Embodiment 1 described above. The controller 106 expels the removable medium 101 according to the next medium expelling command, e.g., a change in all the switches 104 and 105 or a command supplied from the outside of the device during the time period from the reception of the medium expelling prohibition cancellation command from the outside of the device to the detection of a record of medium expelling prohibition information in the predetermined area on the medium 101 again performed by the medium expelling prohibition information detector 110 at the time of insertion of the medium 101 into the device. The medium expelling prohibition information includes a medium expelling prohibition cancellation code. If the medium expelling prohibition cancellation command input by a certain operation on the input device 702 includes a medium expelling prohibition cancellation code, and if this medium expelling prohibition cancellation code coincides with the code stored on the medium 101 or in the nonvolatile storage 301 of the removable medium recording/reproduction device 109, the medium expelling prohibition cancellation command is recognized (accepted as a valid command) and the medium expelling prohibition flag is cleared.

According to Embodiment 2 of the present invention, as described above, a removable medium recording/reproduction device, a removable medium expelling control method for the removable medium recording/reproduction device and a removable medium expelling control method for an information processing apparatus can be provided in which prohibition of expelling of the medium 101 can be controlled by using medium expelling prohibition information recorded in a predetermined area on the medium 101, and expelling of the medium 101 is prohibited during detection of the existence/nonexistence of the medium 101 or before determination as to whether or not the expelling prohibition information is recorded on the medium immediately after power-on of the device, whereby it is ensured that expelling of the medium 101 immediately after power-on of the device can be prevented. Further, information indicating that the medium 101 exists in the device is stored as medium expelling prohibition information in the nonvolatile storage 301 in the device, and the medium expelling prohibition flag recorded in the nonvolatile storage 301 is held even during power-down of the device, thereby eliminating the drawback of allowing the medium 101 on which medium expelling prohibition information is recorded to be expelled in a situation where, when the removable medium 101 is in the device, medium recognition processing is not completed immediately after powering on the device. It is thereby ensured that the expelling prohibiting state is not canceled even after powering off the device, and that determination can be made as to whether or not each of mediums inserted in the device is allowed to be expelled by a user.

According to Embodiment 2 of the present invention, a removable medium recording/reproduction device, a removable medium expelling control method for the removable medium recording/reproduction device and a removable medium expelling control method for an information processing apparatus can be provided in which the removable medium loading/ejection mechanism of the removable medium recording/reproduction device 109 is arranged so that the medium 101 cannot be forcibly expelled during power-down or at the time of resetting of the device, whereby it is ensured that forced expelling of the medium 101 using the forced expelling mechanism can be prevented during power-down, and that it is difficult for any person other than the person who has set medium expelling prohibition to cancel medium expelling prohibition.

In Embodiment 2, the arrangement may be such that the input device 702 in the second controller 701 is operated to record medium expelling prohibition information in a predetermined area on the medium 101 and record the medium expelling flag in the nonvolatile storage 301.

In Embodiment 2, the arrangement may also be such that, in the second controller 701, a medium expelling prohibition cancellation code is generated by inputting a sequence of characters input by an operation on the input device 702 or by converting the input sequence of characters by a certain rule; medium expelling prohibition information including the generated medium expelling prohibition cancellation code is recorded in the predetermined area on the medium 101; the medium expelling prohibition flag is recorded in the nonvolatile storage 301; determination is made as to whether or not an input including the medium expelling prohibition cancellation code or data obtained by converting the medium expelling prohibition cancellation code by a certain rule has been provided as the medium expelling prohibition cancellation command by an operation on the input device 702; and, if it is determined that an input including the medium expelling prohibition cancellation code or data obtained by converting the medium expelling prohibition cancellation code by a certain rule has been provided, the medium expelling prohibition flag in the nonvolatile storage 301 is cleared.

### EMBODIMENT 3

Description will be made of Embodiment 3 of the present invention with reference to FIGS. 1, 2, and 7. The same components as those of Embodiment 1 described above are indicated by the same reference numerals and the description for them will not be repeated.

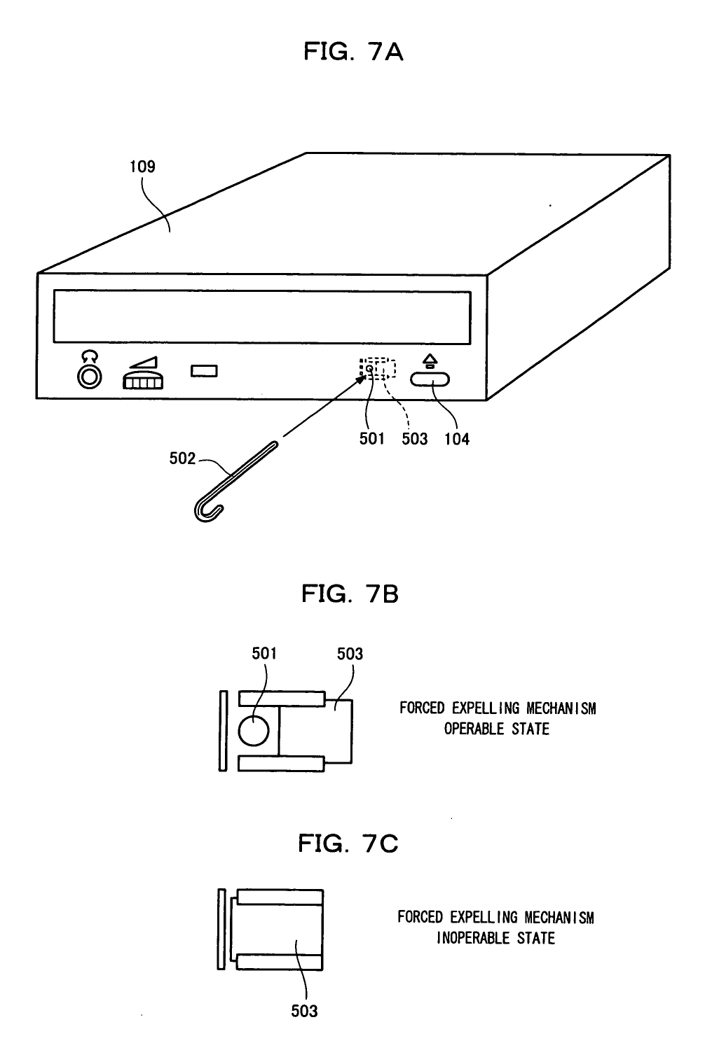

FIG. 7 comprises an external view of a device which is an application of the present invention to a CD-R/RW recording/reproduction device, and diagrams showing an example of a mechanism for selecting between operability and inoperability of a mechanism for forcibly expelling a medium.

In FIG. 7, reference numeral 501 denotes a forced expelling hole provided at the front of a removable recording/reproduction device 109 for insertion of a pin 502 for operating the mechanism (not shown) for forcibly expelling the medium 101. The pin 502 is thrust (inserted) into the forced expelling hole 501 and a forced expelling lever interlocked with there movable medium loading ejection mechanism is pressed with the pin 502 to operate the forced expelling mechanism, thereby forcibly expelling the removable medium 101 during power-down the device or in the event of emergency. While in Embodiments 1 and 2 described above the removable medium loading/ejection mechanism cannot forcibly expel the medium 101 during power-down of the device, Embodiment 3 is arranged so that the medium 101 can be forcibly expelled.

As shown in FIGS. 7(b) and 7(c), a shutter 503 for opening/closing the forced expelling hole 501 is provided in the removable medium recording/reproduction device 109. In a forced expelling mechanism operable state shown in FIG. 7(b), the shutter 503 is open. In a forced expelling mechanism inoperable state shown in FIG. 7(c), the forced expelling mechanism is made inoperably by driving the shutter 503 with a combination of members such as a gear and an arm (not shown) interlocked with the loading mechanism so that the forced expelling hole 501 is closed. Thus, the shutter 503 is a forced expelling mechanism changer for mechanically changing the forced expelling mechanism between the operable state (shutter closed state/pin non-insertable state) and the inoperable state (shutter opened state/pin insertable state).

As described above, the removable medium loading/ejection mechanism has the forced expelling mechanism for forcibly expelling the medium at the time of power-down of the device for example, and the forced expelling mechanism changer for mechanically changing the forced expelling mechanism between the inoperable state and the operable state.

The flow of medium recognition processing operation and the flow of medium expelling processing (FIG. 2) by the controller 106 in Embodiment 3 differ from the operation of Embodiment 1 only in step-S203.

That is, if the controller 106 determines in step-S203 that medium expelling prohibition information is recorded, it sets the medium expelling prohibition flag, drives the shutter 503 to close the forced expelling hole 501 and terminates medium recognition processing. The forced expelling mechanism is thereby made mechanically inoperable.

When the controller 106 receives the medium expelling prohibition cancellation command sent from the second controller 701 via the interface 107 according to an operation on the input device 702 of the host computer 108, it cancels medium expelling prohibition by turning off the medium expelling prohibition flag, sets the forced expelling mechanism in the operable state by opening the shutter 503, and expels the removable medium 101 according to the next medium expelling command. In the state after the shutter 503 has been opened to make the forced expelling mechanism operable, the forced expelling mechanism can be operated by inserting the pin 502 in the forced expelling hole 501.

According to Embodiment 3, as described above, a removable medium recording/reproduction device, a removable medium expelling control method for the removable medium recording/reproduction device and a removable medium expelling control method for an information processing apparatus can be provided in which prohibition of expelling of the removable medium 101 can be controlled by using medium expelling prohibition information recorded in a predetermined area on the removable medium 101, and expelling of the medium 101, and in which, if a forced medium expelling mechanism is provided, the forced medium expelling mechanism is changed between operable and inoperable states, whereby it is ensured that the expelling prohibiting state is not canceled even after powering off the device, and that determination can be made as to whether or not each of mediums inserted in the device is allowed to be expelled by a user.

Embodiment 3 has been described with respect to a case where the forced expelling mechanism is operated by inserting the pin 502 into the forced expelling hole. 501. However, the present invention can be implemented in a similar manner in other cases of using different mechanisms for mechanically and forcibly expelling the medium, e.g., a case where a method of forced expelling by rotating a gear in the medium expelling mechanism with a special-purpose jig is used.

Embodiment 3 has been described by way of example with respect to a case where the shutter 503 is used as a forced expelling mechanism changer for changing the forced expelling mechanism between the inoperable state and the operable state. However, the above-described forced expelling mechanism changer may be constructed so that the forced expelling lever of the force expelling mechanism can be selectively changed between a position at which the medium 101 can be forcibly expelled by inserting the pin 502 into the forced expelling hole 501 and a position at which the medium cannot be forcibly expelled by inserting the pin 502 into the forced expelling hole 501. Further, the present invention can be implemented in a similar manner by using a method of making the forced expelling mechanism inoperable regardless of the power supply on/off state, for example, by mechanically locking the forced expelling mechanism.

### EMBODIMENT 4

Description will be made of Embodiment 4 of the present invention with reference to FIGS. 1 to 3, and 8. The same components as those of Embodiment 1 described above are indicated by the same reference numerals and the description for them will not be repeated. Also, the flow of medium recognition processing, the flow of medium expelling processing and the flow of medium expelling prohibition cancellation processing are the same as those in Embodiment 1 and the description for them will not be repeated.

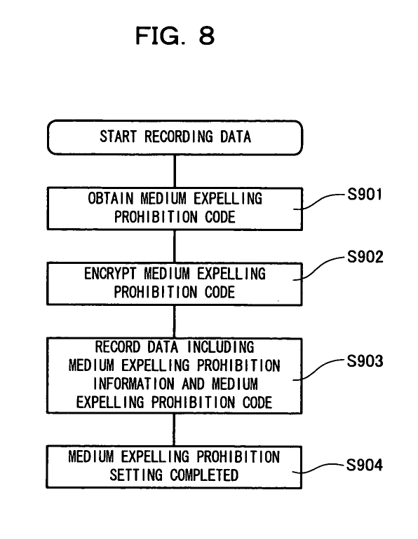

FIG. 8 is a flowchart showing an operation to record data on the removable medium of the present invention described in the description of this embodiment.

The operation when medium expelling prohibition information is recorded on the medium 101 will be described with reference to FIG. 8.

Step-S901

The second controller 701 first obtains a medium expelling prohibition code when starting recording. Conceivable examples of a method of setting a medium expelling prohibition code are a method in which an administrator of the information processing apparatus sets a medium expelling prohibition code in a piece of recording control software in advance, and a method in which an administrator of the information processing apparatus sets a medium expelling prohibition code in advance in a nonvolatile storage (not shown) in the removable medium recording/reproduction device 109.

Step-S902

Subsequently, the second controller 701 encrypts the obtained medium expelling prohibition code by a certain rule. Needless to say, it is not necessary to encrypt the medium expelling prohibition code in a case where the medium expelling prohibition code is recorded so that the code cannot be easily read, or in a case where the required security level is not so high.

Step-S903

Subsequently, the second controller 701 starts recording data. If the medium expelling prohibition information and the medium expelling prohibition code are embedded in subcode information at the time of recording in a CD-R/RW recording/reproduction device for example, the information and the code are recorded while being encoded along with the data to be recorded.

Step-S904

When the recording operation is completed, the second controller 701 sets the device in the medium expelling prohibiting state and terminates the recording operation.

According to Embodiment 4 of the present invention, as described above, a medium expelling control method for a removable medium recording/reproduction device in an information recording/reproduction apparatus can be provided in which medium expelling prohibition information is forcibly recorded at the time of recording of data on the medium 101, whereby it is ensured that taking out of data from the inside of an information processing apparatus to the outside by means of the removable medium 101 can be restricted.

Embodiment 4 has been described by way of example with respect to a case where medium expelling prohibition information and a medium expelling prohibition code are recorded together with data by being embedded in subcode information in a CD-R/RW recording/reproduction device. However, the present invention can be implemented in a similar manner by using any other method of recording in a readable area on a medium, e.g., a method of recording in a portion of TOC information on a CD-R/RW, a method of recording in a special-purpose area provided on a different kind of medium, or a method of recording in an area other than the ordinary data recording area, e.g., a nonvolatile memory area on a medium on which an IC chip or the like is mounted. In a case where medium expelling prohibition information is recorded without being embedded in data, the invention can be implemented in a similar manner by recording the medium expelling prohibition information before or after data recording. However, if the power supply for the information processing apparatus is forcibly turned off before the medium expelling prohibition information is recorded after data recording, the medium is made expellable. From consideration of this, it is preferable to record the medium expelling prohibition information before data recording.

While use of a disk medium in conformity with the CD-ROM/R/RW standard has been described by way of example in the descriptions of Embodiments 1 to 4, the present invention can be implemented in a similar manner by using any other medium, e.g., a disk medium such as a DVD-ROM/R/RW, or a non-disk medium such as a tape or a memory card.

While Embodiments 1 to 4 have been described with respect to a case where the medium transporter 102 is a tray, the present invention can be implemented in a similar manner by using any other mechanism, e.g., rollers in a slot-loading system, an arm for drawing in a medium, or a mechanism motor-driven to load or eject a non-disk medium.

While Embodiments 1 to 4 have been described with respect to a case where the switch 104 provided on an outer portion of the device is provided, the present invention can be implemented in a similar manner in the case of expelling the medium only by receiving the medium expelling command sent from the host computer 108 via the interface 107, without being provided with the switch 104 provided on an outer portion of the device.

### INDUSTRIAL APPLICABILITY

In a removable medium recording/reproduction device, a medium expelling control method for the removable medium recording/reproduction device and a removable medium expelling control method for an information processing apparatus in accordance with the present invention, prohibition of expelling of the removable medium is controlled by using medium expelling prohibition information recorded in a predetermined area on the removable medium, and expelling of the medium is prohibited before determination as to whether or not the expelling prohibition information is recorded on the medium immediately after power-on, whereby it is ensured that the expelling prohibiting state is not canceled even after powering off the device, and that determination can be made as to whether or not each of mediums inserted in the device is allowed to be expelled by a user. Therefore, the present invention is useful in an application to a removable medium recording/reproduction device or an information processing apparatus with a removable medium recording/reproduction device in which it is desirable from the viewpoint of security to prevent a medium from being easily expelled, for example, an application for preventing a removable medium containing secret information from being expelled and taken out of a device.

1. A removable medium recording/reproduction device having a removable medium loading/ejection mechanism which operates according to a change in state of switches each provided on an outer portion or on an inner portion of the device or according to a command from the outside of the device to transport a removable medium into the device and to set the removable medium in a reproducible state or to transport and expel the removable medium out of the device, the device comprising:
a medium expelling prohibition information detector which detects whether or not medium expelling prohibition information is recorded in a predetermined area on a removable medium; and
a controller which, if a record of medium expelling prohibition information is detected by the medium expelling prohibition information detector, does not perform expelling of the medium due to a change in state of the switches or a command from the outside of the device, and which, if no record of medium expelling prohibition information is detected by the medium expelling prohibition information detector, operates the removable medium loading/ejection mechanism to expel the medium according to the change in state of the switches or the command from the outside of the device.

2. A removable medium recording/reproduction device having a removable medium loading/ejection mechanism which operates according to a change in state of switches each provided on an outer portion or on an inner portion of the device or according to a command from the outside of the device to transport a removable medium into the device and to set the removable medium in a reproducible state or to transport and expel the removable medium out of the device, the device comprising:
a medium expelling prohibition information detector which detects whether or not medium expelling prohibition information is recorded in a predetermined area on a removable medium;
a removable medium detector which detects whether or not a removable medium is in the device; and
a controller which does not perform expelling of the medium due to a change in state of the switches or a command from the outside of the device during detection of the existence/nonexistence of the removable medium by the removable medium detector, during detection by the medium expelling prohibition information detector as to whether or not medium expelling prohibition information on the removable medium is recorded, or if a record of medium expelling prohibition information is detected by the medium expelling prohibition information detector, and
which, if the existence of a removable medium in the device is detected by the removable medium detector, and if no record of medium expelling prohibition information on the removable medium is detected by the medium expelling prohibition information detector, operates the removable medium loading/ejection mechanism to expel the medium according to the change in state of the switches or the command from the outside of the device.

3. The removable medium recording/reproduction device according to claim 1, wherein the removable medium loading/ejection mechanism cannot forcibly expel the removable medium during power-down of the device.

4. The removable medium recording/reproduction device according to claim 1, wherein the controller expels the medium according to the change in state of all the switches or the command from the outside of the device in the time period from reception of a medium expelling prohibition cancellation command from the outside of the device to detection of medium expelling prohibition information in the predetermined area on the removable medium performed by the medium expelling prohibition information detector upon reinsertion of the removable medium into the device.

5. The removable medium recording/reproduction device according to claim 4, wherein the medium expelling prohibition information includes a medium expelling prohibition cancellation code, and the controller accepts the medium expelling prohibition cancellation command as a valid command only if the medium expelling prohibition cancellation command includes the medium expelling prohibition cancellation code or data obtained by converting the medium expelling prohibition cancellation code by a certain rule.

6. A removable medium recording/reproduction device having a removable medium loading/ejection mechanism which operates according to a change in state of switches each provided on an outer portion or on an inner portion of the device or according to a command from the outside of the device to transport a removable medium into the device and to set the removable medium in a reproducible state or to transport and expel the removable medium out of the device, the device comprising:
a nonvolatile storage which is capable of holding storage contents even after power supply for the removable medium recording/reproduction device has been shut off, and which is rewritable;
a medium expelling prohibition information detector which detects whether or not medium expelling prohibition information is recorded in a predetermined area on a removable medium; and
a controller which records a medium expelling prohibition flag in the nonvolatile storage when the medium expelling prohibition information detector detects a record of medium expelling prohibition information,
which, if the medium expelling prohibition flag is recorded in the nonvolatile storage, does not perform expelling of the medium due to a change in state of the switches or a command from the outside of the device, and
which, if the medium expelling prohibition flag is not recorded in the nonvolatile storage, operates the removable medium loading/ejection mechanism to expel the medium according to the change in state of the switches or the command from the outside of the device.

7. The removable medium recording/reproduction device according to claim 6, wherein the removable medium loading/ejection mechanism cannot forcibly expel the removable medium during power-down of the device.

8. The removable medium recording/reproduction device according to claim 6, wherein the controller clears the medium expelling prohibition flag in the nonvolatile storage when the medium expelling prohibition cancellation command from the outside of the device is received.

9. The removable medium recording/reproduction device according to claim 8, wherein the medium expelling prohibition information includes a medium expelling prohibition cancellation code, and the controller accepts the medium expelling prohibition cancellation command as a valid command only if the medium expelling prohibition cancellation command includes the medium expelling prohibition cancellation code or data obtained by converting the medium expelling prohibition cancellation code by a certain rule.

10. The removable medium recording/reproduction device according to claim 1, wherein the removable medium loading/ejection mechanism has:
a forced expelling mechanism capable of forcibly expelling the medium during power-down of the device; and
a forced expelling mechanism changer which mechanically changes the forced expelling mechanism between an inoperable state and an operable state, and
wherein the controller operates to set the forced expelling mechanism in the inoperable state by controlling the forced expelling mechanism changer if the medium expelling prohibition information is recorded, and to set the forced expelling mechanism in the operable state by controlling the forced expelling mechanism changer if the medium expelling prohibition information is not recorded.

11. The removable medium recording/reproduction device according to claim 10, wherein the forced expelling mechanism in the removable medium loading/ejection mechanism is arranged to forcibly expel the medium by inserting a pin into a hole provided in a front surface of the device during power-down of the device, and
wherein the forced expelling mechanism changer of the removable medium loading/ejection mechanism is arranged to mechanically change the forced expelling mechanism between the inoperable state and the operable state by opening and closing the hole provided in the front surface of the device.

12. The removable medium recording/reproduction device according to claim 10, wherein the forced expelling mechanism in the removable medium loading/ejection mechanism is arranged to forcibly expel the medium by inserting a pin into a hole provided in a front surface of the device during power-down of the device and by pressing a forced expelling lever interlocked with the loading/ejection mechanism with the pin, and
wherein the forced expelling mechanism changer of the removable medium loading/ejection mechanism is arranged to selectively change the forced expelling lever between a position at which the medium can be forcibly expelled by inserting the pin into the hole and a position at which the medium cannot be forcibly expelled by inserting the pin into the hole.

13. A medium expelling control method for a removable medium recording/reproduction device having a removable medium loading/ejection mechanism which operates according to a change in state of switches each provided on an outer portion or on an inner portion of the device or according to a command from the outside of the device to transport a removable medium into the device and to set the removable medium in a reproducible state or to transport and expel the removable medium out of the device, the method comprising:
determining whether or not medium expelling prohibition information is recorded in a predetermined area on a removable medium;
not performing expelling of the medium due to a change in state of the switches or a command from the outside of the device if it is determined that the medium expelling prohibition information is recorded; and
operating the removable medium loading/ejection mechanism to expel the medium according to the change in state of the switches or the command from the outside of the device if it is determined that the medium expelling prohibition information is not recorded.

14. A medium expelling control method for a removable medium recording/reproduction device having a removable medium loading/ejection mechanism which operates according to a change in state of switches each provided on an outer portion or on an inner portion of the device or according to a command from the outside of the device to transport a removable medium into the device and to set the removable medium in a reproducible state or to transport and expel the removable medium out of the device, the method comprising:
not performing expelling of the medium due to a change in state of the switches or a command from the outside of the device if it is determined that detection as to whether or not a removable medium exists in the device is being performed, if it is determined that detection as to whether or not medium expelling prohibition information is recorded in a predetermined area on a removable medium is being performed, or if it is determined that medium expelling prohibition information is recorded; and
operating the removable medium loading/ejection mechanism to expel the medium according to the change in state of the switches or the command from the outside of the device if it is determined that a removable medium exists in the device, and if it is determined that medium expelling prohibition information is not recorded on the removable medium.

15. The medium expelling control method for a removable medium recording/reproduction device according to claim 13, further comprising:
canceling medium expelling prohibition when a medium expelling prohibition cancellation command is received from the outside of the device; and
expelling the medium according to the change in state of all the switches or the command from the outside of the device in the time period from the cancellation of the medium expelling prohibition to detection of a record of the medium expelling prohibition information in the predetermined area on the removable medium performed upon reinsertion of the removable medium into the device.

16. The medium expelling control method for a removable medium recording/reproduction device according to claim 15, wherein the medium expelling prohibition information includes a medium expelling prohibition cancellation code, the method further comprising making determination as to whether or not the medium expelling prohibition cancellation command includes the medium expelling prohibition cancellation code or data obtained by converting the medium expelling prohibition cancellation code by a certain rule, and accepting the medium expelling prohibition cancellation command as a valid command if it is determined that the medium expelling prohibition cancellation command includes the medium expelling prohibition cancellation code or the data.

17. A medium expelling control method for a removable medium recording/reproduction device having a removable medium loading/ejection mechanism which operates according to a change in state of switches each provided on an outer portion or on an inner portion of the device or according to a command from the outside of the device to transport a removable medium into the device and to set the removable medium in a reproducible state or to transport and expel the removable medium out of the device, and a nonvolatile storage, the method comprising:
determining whether or not medium expelling prohibition information is recorded in a predetermined area on a removable medium;
recording a medium expelling prohibition flag in the nonvolatile storage when the medium expelling prohibition information detector detects a record of medium expelling prohibition information;
making determination as to whether or not the medium expelling prohibition flag is recorded in the nonvolatile storage;
not performing expelling of the medium due to a change in state of the switches or a command from the outside of the device if it is determined that the medium expelling prohibition flag is recorded in the nonvolatile storage; and
operating the removable medium loading/ejection mechanism to expel the medium according to the change in state of the switches or the command from the outside of the device if it is determined that the medium expelling prohibition flag is not recorded in the nonvolatile storage.

18. The medium expelling control method for a removable medium recording/reproduction device according to claim 17, further comprising clearing the medium expelling prohibition flag in the nonvolatile storage when the medium expelling prohibition cancellation command from the outside of the device is received.

19. The medium expelling control method for a removable medium recording/reproduction device according to claim 18, wherein the medium expelling prohibition information includes a medium expelling prohibition cancellation code, the method further comprising making determination as to whether or not the medium expelling prohibition cancellation command includes the medium expelling prohibition cancellation code or data obtained by converting the medium expelling prohibition cancellation code by a certain rule, and accepting the medium expelling prohibition cancellation command as a valid command if it is determined that the medium expelling prohibition cancellation command includes the medium expelling prohibition cancellation code or the data.

20. The medium expelling control method for a removable medium recording/reproduction device according to claim 13, wherein the removable medium loading/ejection mechanism has a forced expelling mechanism capable of forcibly expelling the medium during power-down of the device, and a forced expelling mechanism changer which mechanically changes the forced expelling mechanism between an inoperable state and an operable state, the method further comprising:
setting the forced expelling mechanism in the inoperable state by controlling the forced expelling mechanism changer not to expel the medium according to the change in state of the switches or the command from the outside of the device, and
setting the forced expelling mechanism in the operable state by controlling the forced expelling mechanism changer to operate the removable medium loading/ejection mechanism so as to expel the medium according to the change in state of the switches or the command from the outside of the device.

21. A removable medium expelling control method for an information processing apparatus having a removable medium loading/ejection mechanism which operates according to a change in state of switches each provided on an outer portion or on an inner portion of the apparatus or according to a command from the outside of the apparatus to transport a removable medium into the apparatus and to set the removable medium in a reproducible state or to transport and expel the removable medium out of the apparatus, a controller which reads out data from the removable medium or records data on the removable medium, and which processes data read out from the removable medium, and an input device for enabling a user to operate the controller as desired, the method comprising:
determining whether or not medium expelling prohibition information is recorded in a predetermined area on a removable medium;
not performing expelling of the medium due to a change in state of the switches or a command from the input device if it is determined that the medium expelling prohibition information is recorded; and
operating the removable medium loading/ejection mechanism to expel the medium according to the change in state of the switches or the command from the input device if it is determined that the medium expelling prohibition information is not recorded.

22. A removable medium expelling control method for an information processing apparatus having a removable medium loading/ejection mechanism which operates according to a change in state of switches each provided on an outer portion or on an inner portion of the apparatus or according to a command from the outside of the apparatus to transport a removable medium into the apparatus and to set the removable medium in a reproducible state or to transport and expel the removable medium out of the apparatus, a controller which reads out data from the removable medium or records data on the removable medium, and which processes data read out from the removable medium, and an input device for enabling a user to operate the controller as desired, the method comprising:
not performing expelling of the medium due to a change in state of the switches or a command from the outside of the apparatus if it is determined that detection as to whether or not a removable medium exists in the apparatus is being performed, if it is determined that detection as to whether or not medium expelling prohibition information is recorded in a predetermined area on the removable medium is being performed, or if it is determined that the medium expelling prohibition information is recorded; and
operating the removable medium loading/ejection mechanism to expel the medium according to the change in state of the switches or the command from the outside of the apparatus if it is determined that removable medium exists in the apparatus, and if it is determined that the medium expelling prohibition information is not recorded on the removable medium.

23. The removable medium expelling control method for an information processing apparatus according to claim 21, further comprising:
canceling medium expelling prohibition by a certain operation on the input device; and
expelling the medium according to the change in state of all the switches or the command from the outside of the apparatus in the time period from the cancellation of the medium expelling prohibition to detection of a record of the medium expelling prohibition information in the predetermined area on the removable medium performed upon reinsertion of the removable medium into the apparatus.

24. The removable medium expelling control method for an information processing apparatus according to claim 23, wherein the medium expelling prohibition information includes a medium expelling prohibition cancellation code, the method further comprising, when an input including the medium expelling prohibition cancellation code or data obtained by converting the medium expelling prohibition cancellation code by a certain rule is provided as a medium expelling prohibition cancellation command by an operation on the input device, accepting the medium expelling prohibition cancellation command as a valid command.

25. The removable medium expelling control method for an information processing apparatus according to claim 21, further comprising recording the medium expelling prohibition information in the predetermined area on the recordable removable medium by an operation on the input device.

26. The removable medium expelling control method for an information processing apparatus according to claim 21, further comprising:
generating a medium expelling prohibition cancellation code obtained by inputting a sequence of characters by an operation on the input device or by converting the input sequence of characters by a certain rule;
recording medium expelling prohibition information including the generated medium expelling prohibition cancellation code in the predetermined area on the recordable removable medium;
when the medium expelling prohibiting state is canceled by an operation on the input device, canceling the medium expelling prohibition if an input including the medium expelling prohibition cancellation code or data obtained by converting the medium expelling prohibition cancellation code by a certain rule is provided; and
expelling the medium according to a change in state of all the switches or a command from the input device in the time period from the cancellation of the medium expelling prohibition to detection of a record of the medium expelling prohibition information in the predetermined area on the medium performed upon reinsertion of the removable medium into the apparatus.

27. The removable medium expelling control method for an information processing apparatus according to claim 21, further comprising:
forcibly recording the medium expelling prohibition information in the predetermined area on the removable medium when data is recorded on the removable medium; and
setting the apparatus in a medium expelling prohibiting state after the completion of the recording.

28. A removable medium expelling control method for an information processing apparatus having a removable medium loading/ejection mechanism which operates according to a change in state of switches each provided on an outer portion or on an inner portion of the apparatus or according to a command from the outside of the apparatus to transport a removable medium into the apparatus and to set the removable medium in a reproducible state or to transport and expel the removable medium out of the apparatus, a nonvolatile storage, a controller which reads out data from the removable medium or records data on the removable medium, and which executes data read out from the removable medium, and an input device for enabling a user to operate the controller as desired, the method comprising:
determining whether or not medium expelling prohibition information is recorded in a predetermined area on a removable medium;
recording a medium expelling prohibition flag in the nonvolatile storage if it is determined that medium expelling prohibition information is recorded;
determining whether or not the medium expelling prohibition flag is recorded in the nonvolatile storage;
not performing expelling of the medium due to a change in state of the switches or a command from the outside of the apparatus if it is determined that the medium expelling prohibition flag is recorded in the nonvolatile storage; and
operating the removable medium loading/ejection mechanism to expel the medium according to the change in state of the switches or the command from the input device if it is determined that the medium expelling prohibition flag is not recorded in the nonvolatile storage.

29. The removable medium expelling control method for an information processing apparatus according to claim 28, further comprising:
canceling medium expelling prohibition by a certain operation on the input device; and
clearing the medium expelling prohibition flag in the nonvolatile storage when the medium expelling prohibition is canceled.

30. The removable medium expelling control method for an information processing apparatus according to claim 29, wherein the medium expelling prohibition information includes a medium expelling prohibition cancellation code, the method further comprising, when an input including the medium expelling prohibition cancellation code or data obtained by converting the medium expelling prohibition cancellation code by a certain rule is provided as a medium expelling prohibition cancellation command by an operation on the input device, accepting the medium expelling prohibition cancellation command as a valid command.

31. The removable medium expelling control method for an information processing apparatus according to claim 28, further comprising recording the medium expelling prohibition information in the predetermined area on the recordable removable medium by an operation on the input device, and recording the medium expelling flag in the nonvolatile storage.

32. The removable medium expelling control method for an information processing apparatus according to claim 28, further comprising:
generating a medium expelling prohibition cancellation code obtained by inputting a sequence of characters by an operation on the input device or by converting the input sequence of characters by a certain rule;
recording medium expelling prohibition information including the generated medium expelling prohibition cancellation code in the predetermined area on the recordable removable medium, and recording the medium expelling prohibition flag in the nonvolatile storage;
making determination as to whether or not an input including the medium expelling prohibition cancellation code or data obtained by converting the medium expelling prohibition cancellation code by a certain rule has been provided as a medium expelling prohibition cancellation command by an operation on the input device;
clearing the medium expelling prohibition flag in the nonvolatile storage if it is determined that an input including the medium expelling prohibition cancellation code or data obtained by converting the medium expelling prohibition cancellation code by a certain rule has been provided.

33. The removable medium expelling control method for an information processing apparatus according to claim 28, further comprising:
forcibly recording the medium expelling prohibition information in the predetermined area on the removable medium when data is recorded on the removable medium; and
setting the apparatus in a medium expelling prohibiting state after the completion of the recording.

34. The removable medium expelling control method for an information processing apparatus according to claim 21, wherein the removable medium loading/ejection mechanism has a forced expelling mechanism capable of forcibly expelling the medium during power-dowm of the apparatus, and a forced expelling mechanism changer which mechanically changes the forced expelling mechanism between an inoperable state and an operable state, the method further comprising:
setting the forced expelling mechanism in the inoperable state by controlling the forced expelling mechanism changer not to expel the medium according to the change in state of the switches or the command from the input device, and
setting the forced expelling mechanism in the operable state by controlling the forced expelling mechanism changer to operate the removable medium loading/ejection mechanism so as to expel the medium according to the change in state of the switches or the command from the input device.
